(19) United States
(12) Patent Application Publication
(10) Pub. No.: US 2014/0149343 A1
(43) Pub. Date: May 29, 2014

(54) METHOD OF COMBINED CORRELATIONAL LIST COMPOSITION AND UTILIZATION THEREOF

(71) Applicant: Vasyl Herasymchuk, Lviv (UA)

(72) Inventor: Vasyl Herasymchuk, Lviv (UA)

(21) Appl. No.: 14/087,019

(22) Filed: Nov. 22, 2013

Related U.S. Application Data
(60) Provisional application No. 61/730,082, filed on Nov. 27, 2012.

(51) Int. Cl. G06F 17/30

(52) U.S. Cl. CPC G06F 17/30345
USPC 707/609

(57) ABSTRACT

A method of combined correlational list composition and utilization thereof is disclosed. The method allows composing the list and efficiently utilizing it in different applications. Entries are performed by uploading items on a web site or online creation. The method provides easy way to collaborate while creating input items. Usage of different master lists to adapt the combined correlational list to be associated with other systems lists serves for broader exposure of the combined correlational list items to the public.

### CROSS-REFERENCE TO RELATED APPLICATIONS

This application claims the benefit of priority to U.S. Provisional Application No. 61/730,082 filed Nov. 27, 2012, the contents of which are incorporated herein by reference.

### FIELD OF THE INVENTION

The present invention relates to methods for composing combined correlational list.

### BACKGROUND OF THE INVENTION

Different kind of lists are widely used both in our everyday life not related to computers and networks and in different Internet and computing applications. Methods for creating lists that include tools for sorting and categorizing list items are employed by many computer and network systems. Catalogs and Internet forums employ lists as a general tool. Items like topics or categories in such systems are intended to correlate with associated items.

Methods and systems for crowdsourcing are disclosed (US Patents Applications No. US 2011/0307304 A1, US 2010/0293026 A1, US 2007/0239464 A1). Lists of parties' entries are involved as well. Besides those methods and systems may include collaboration while working on some projects or tasks (US Patents Applications No. US 2013/0080338 A1, US 2010/0287104 A1, US 2009/0198565 A1, US 2006/0218004 A1.)

Nevertheless, these referenced methods and systems don't provide means for easy collaboration between all participants that are working on or might be willing to take part in development within some group of correlated items. Also, they don't facilitate broad presentation of the results of such work. Neither have they proposed multi-variant ways of utilization of the list.

### SUMMARY OF THE INVENTION

Methods of combined correlational list composition and utilization thereof are disclosed.

In one aspect, a method comprises the steps of connecting into a database on a website, creating at least one item; adding at least one item to the database, creating at least one correlated item; adding at least one correlated item to the second database of correlated items; filtering input items using selection criteria; processing input items; grouping individual items with correlated items and converting them into combined correlational list of items by using the computer algorithm; displaying continued combined correlational list based on at least one master list, adding a voting point to at least one correlated item, selecting at least one correlated item; optionally removing at least one item from the combined correlational list of items; optionally deleting at least one item from the database.

In another aspect of the method, the master list is based on a sequence of a first item entry relative to a second item entry, and a sequence of an entry of a first item correlated with the first item relative to an entry of a second item correlated with the first item.

In another aspect of the method, the master list is based on a sequence of a client's item within different list of items.

In another aspect of the method, the creation of a correlated item is performed using provided template.

In another aspect of the method, at least one correlated item is created using at least one different correlated item which is displayed within the combined correlational list.

In another aspect of the method, wherein while displaying continued combined correlational list at least one correlated item is at least partially hidden from at least a part of the system users and conditions under which this information becomes visible are set force by the system's rules.

Interactive request-offer creativity system, comprises at least one requesting items database, at least one offering items database, which requesting items database contains at least one request item, offering items database contains at least one offering item and such requesting and offering items correlate one with each other, and at least one computer program containing an algorithm for request and offer items creation, collaboration on an item creation by providing means for employing at least one existing entry for new item creation, combined correlational list creation, continuously displaying the combined correlational list according to at least one master list, adding voting points and selecting at least one combined correlational list item.

### BRIEF DESCRIPTION OF THE DRAWINGS

FIG. 1 is a flowchart depicting the general process of combined correlational list composition out of individual input items of users.

FIG. 2 is an example of user interface page showing tools and filters in a state of displaying a list with visible first item of each group

FIG. 3 is an example of user interface page showing in a state of displaying a list with visible all items of each group

FIG. 4 is an example of user interface page depicting new item creation process.

FIG. 5 is an example of user interface page showing collaboration on new item creation process.

FIG. 6 is an example of the combined correlational list utilization by using the different system list of items.

FIG. 7 is another example of the combined correlational list utilization by using the different system list of items.

### DETAILED DESCRIPTION OF THE INVENTION

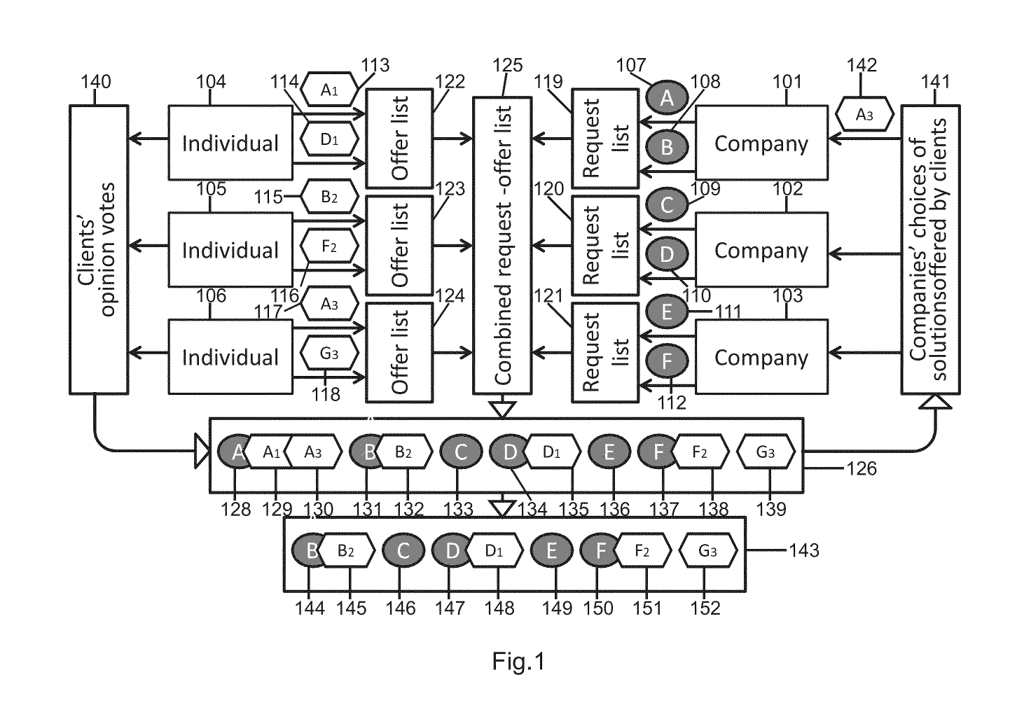

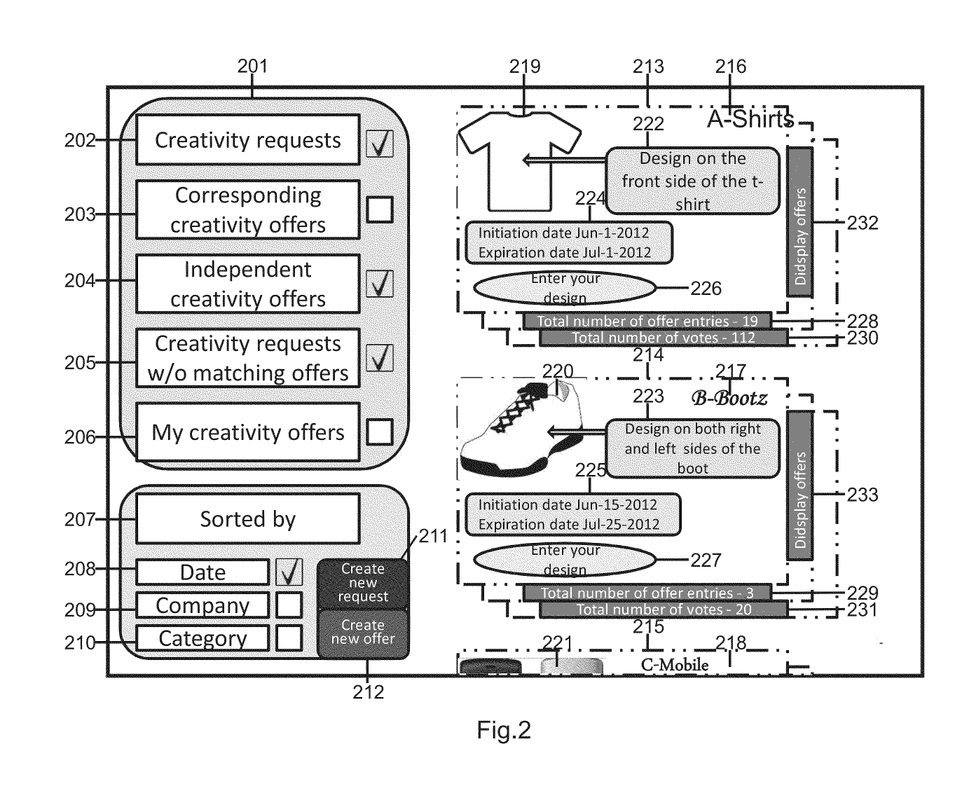

A method of combined correlational list composition and utilization thereof is described herein. Embodiment of the method and the interactive request-offer creativity system described here is depicted by the flowchart (FIG. 1) and sample user interface pages (FIG. 2 through FIG. 7) of the program that utilizes proposed method.

For this description participating types of entities are called “Company” and “Individual”. The flowchart on FIG. 1 shows companies 101, 102, 103 and individuals 104, 105, 106 as parties of the system. They mutually generate components of the combined correlational list. Companies 101, 102, 103 generate requests 107 and 108, 109 and 110, 111 and 112 respectively. These requests form request lists 119, 120 and 121. Individuals 104, 105 and 106 generate offers 113 and 114, 115 and 116, 117 and 118 respectively. These offers form offer lists 122, 123 and 124. Some of the offers (113, 114, 115, 116 and 117) are made per correlated requests (107, 108, 110 and 112) of the companies. Other offers like offer G3 (118) may be created as independent offer, so one of the companies will have a chance to come up with correlated request. Said request lists 119, 120, 121 and offer lists 122, 123, 124 take part in composition of the combined correlational list, called for this embodiment as combined request-offer list 125. Items of the list 125 are grouped, so correlated items are located next to each other and displayed as continuous list 126. Request A (128) is followed by offers A1 (129) and A3 (130) as they belong to the same subject initiated by the request A (128). Similarly, request B (131) is followed by offer B2 (132). Two other groups are D-D1 (134 and 135) and F-F2 (137-138). Requests C (133) and E (136), as well as offer G3 (139) stay separate of any group, since they are not yet populated with correlated items. At this point the list 126 is ready for other actions made both by individuals 104, 105, 106 and by companies 101, 102, 103. Individuals 104, 105, 106 have chance to express their opinion by adding voting points 140. Companies have chance to select the best offers by choosing one or more solutions 141, which are the best and/or worthwhile to be used in their product lines. In given example offer A3 (142) is selected by the company 101, which company has originally posted the request A (107). Depending on criteria set, item or group of correlated items of the list 126 may be removed from this list This event may take place whether when selection of an offer has been made as described above or when request exposition term is expired, or whichever condition happens first. In given example entire group A-A1-A3 (128, 129, 130) is removed and, thus, afterwards the list 143 is displayed without these items. Optionally, request A and offer A3 can be retained on the list 125 and be displayed on the list 126 (143) for determined period of time. So, in general case, combined request-offer list 125 has a form of continuous list, constantly updated by adding and/or removing items.

As it's shown on FIG. 2 user interface of the computer application program may include filter block 201 which allows setting visibility of requests 202, correlated offers 203, independent offers 204, requests that don't have correlated offers yet 205, user's own offers 206. Also, the list can be sorted 207 using different conditions: by the date of appearance 208, by a company name 209 or by a category 210. Buttons 211 and 212 allow creating new request and offer, including independent offer.

Each company's request block 213, 214 and 215 includes its name or logo 216, 217 and 218, pattern, schematic or any other kind of an image 219, 220 or 221, depicting the goal of the request, verbal description of the task 222 and 223, information about initiation and expiration date 224 and 225, button 226 and 227 for starting new offer correlated to requests 213 and 214 respectively. It also may contain some statistics, like total number of offers 228 and 229 correlated to each request and total number of votes 230 and 231 for all of the offers in each group. Since the list is presented in folded state on the FIG. 2 with hidden correlated offers, then each of the request blocks also contain button 232 and 233 for making correlated offers visible.

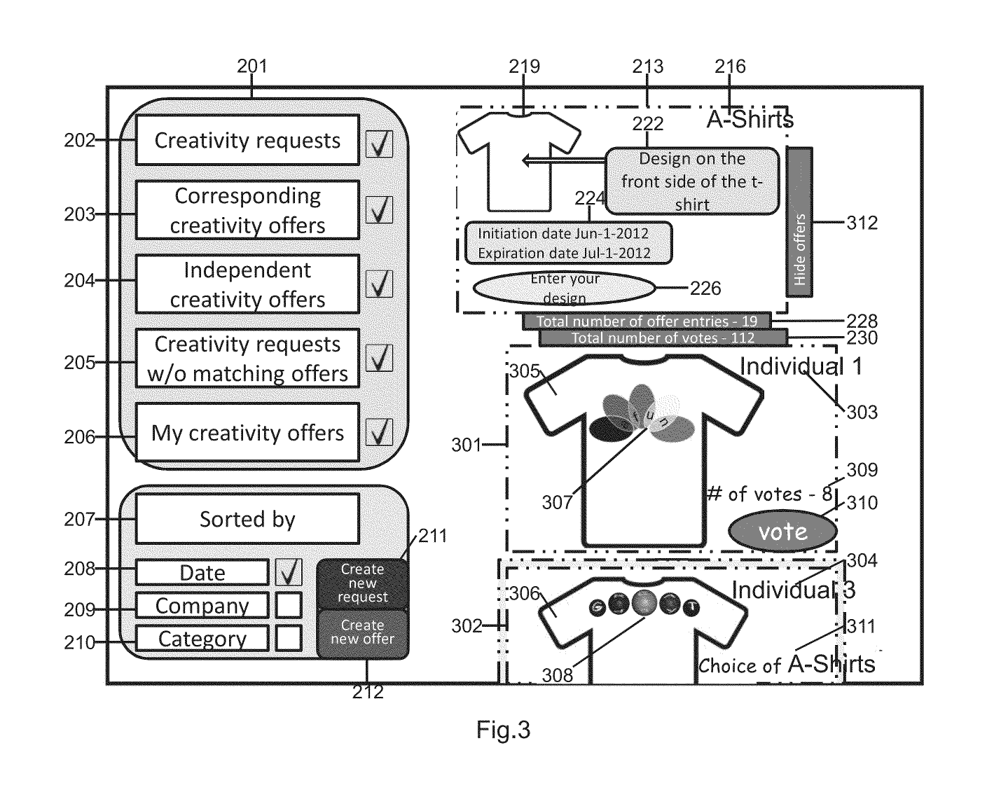

FIG. 3 depicts the screen view of the program user interface that represents all groups of correlated items on the list being visible and laid out in unfolded manner. Beside request block 213, the list representation contains correlated offer blocks 301, 302 and other ones. In given example there should be 19 offer blocks correlated with request 213, Each offer block contains or may contain name of the individual 303 and 304, created certain offer, some kind of a pattern 305 and 306, that corresponds to the one 219 on the request block, offer structure 307 and 308 in a form of image, text, sound or anything else that can represent this correlated offer. Such offer block also contains information about number of votes for this particular offer 309 and a button for voting for it 310. Ones the company 216 has chosen Individual 3 offer, corresponding note 311 appears in the block 302 and the block itself is highlighted or differentiated otherwise from the rest of the offers. Button 312 of the request block 213 hides correlated offers.

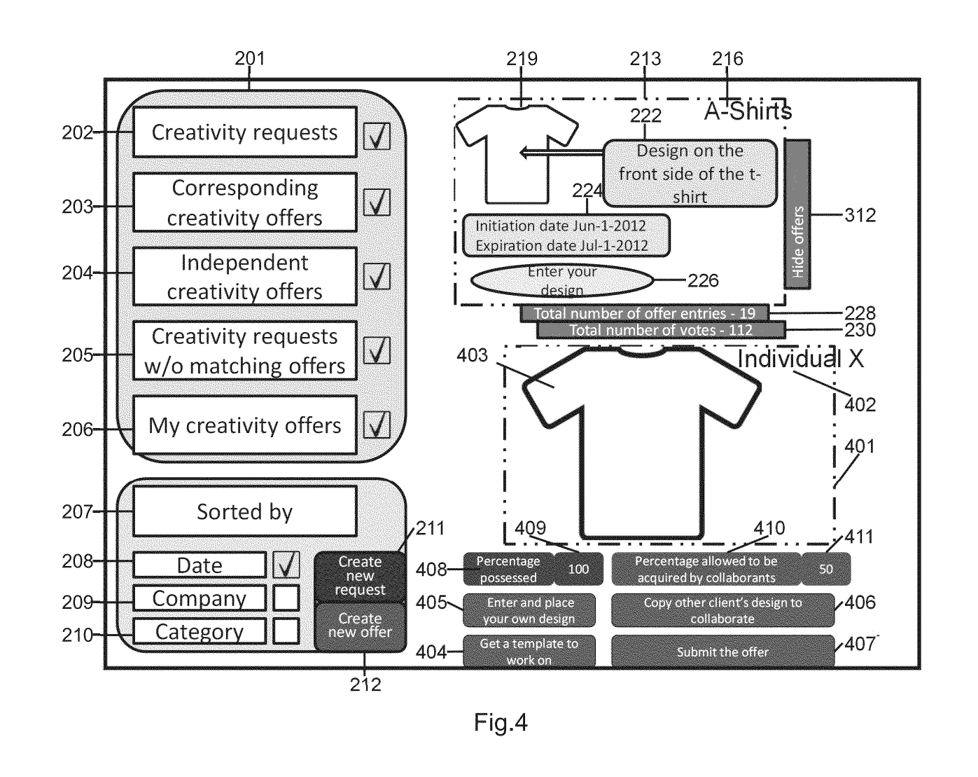

FIG. 4 shows initiation of new offer per request 213. Initiated offer block 401 contains the name of the entity 402, initiated the offer, some pattern 403 to be used for the offer preparation. Also, it contains option buttons that allow getting template 404 to assist in preparation of the offer, bringing and placing individual's design 405, copying other individual's design 406 in order to collaborate and submitting new offer 407, which converts the block 401 to the format of offer blocks 301 and 302 on the FIG. 3. Copying other individual's design 406 starts collaboration session that provides capability to split and distribute ownership of the offer between authors. Button 408, 409 indicates ownership of the design by the current author. It would be 100% for the newly created from the scratch offer. An individual may wish to establish maximum portion of an ownership to be taken by another individual (button 410, 411) should one be willing to use this design in preparation of his/her offer in the future. There may be some default amount set there, like 50%.

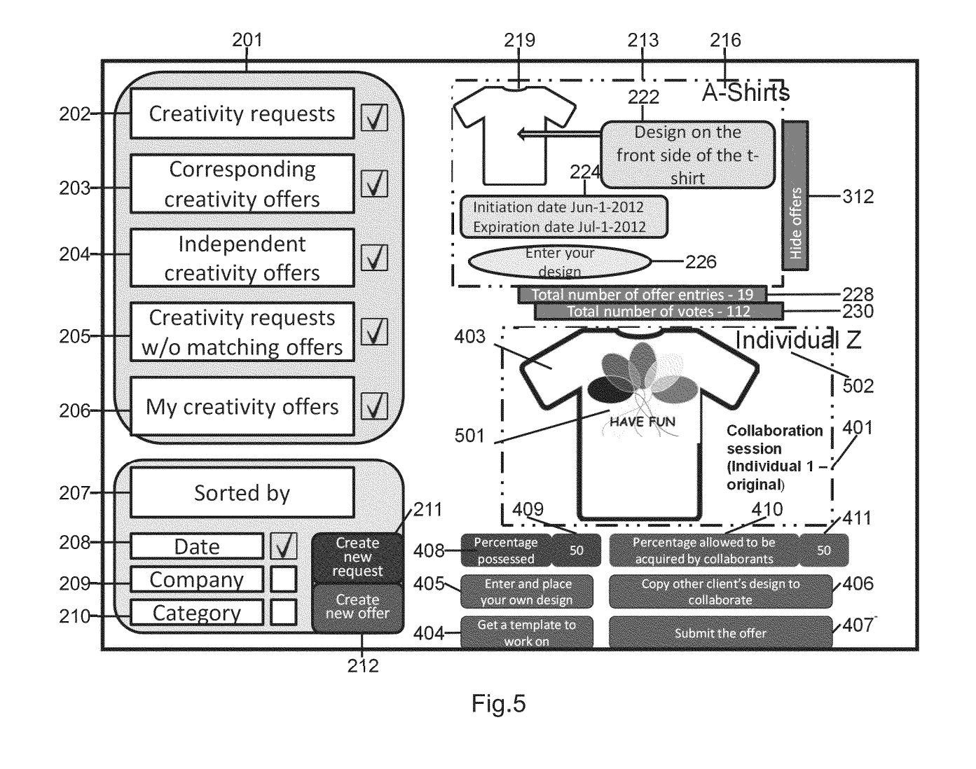

Such case of collaboration is shown on the FIG. 5. The Individual Z (502) uses design of the Individual 1 and adds some more details (501) on the original design. After this Individual Z would have to determine his/her possession (409) in new design as well percentage (out of his/her batch) allowed to be acquired by following author (411). Every following author may take a portion of ownership left after previous ones. Of course, original design by Individual 1 is left within the system and within the list the way it was created to begin with. The same would happen with any modifications made based on this design or based on any of the modifications. Thus, users of the system would have chance to decide whether original version or its' modification is better.

These particular embodiments of the method of combined correlational list composition and the interactive request-offer creativity system allow composing continuous list of requests and offers that correlate with each other, share an opinion about proposed solutions and chose offers that conform companies' criteria the best. Realization of such method and system provides to one of the parties, called herein “companies”, a chance to get a wide selection of solutions per their requests, conduct valuable social study, market and advertize their products. Another party, “individuals” will have unique opportunity to express creativity and individual taste and, also, get a chance to be rewarded by requesting party in case their offer will be chosen by a company. Exposing of the list via such media as Internet will give the system broad social basis, which will ensure that the factors mentioned above have high significance level.

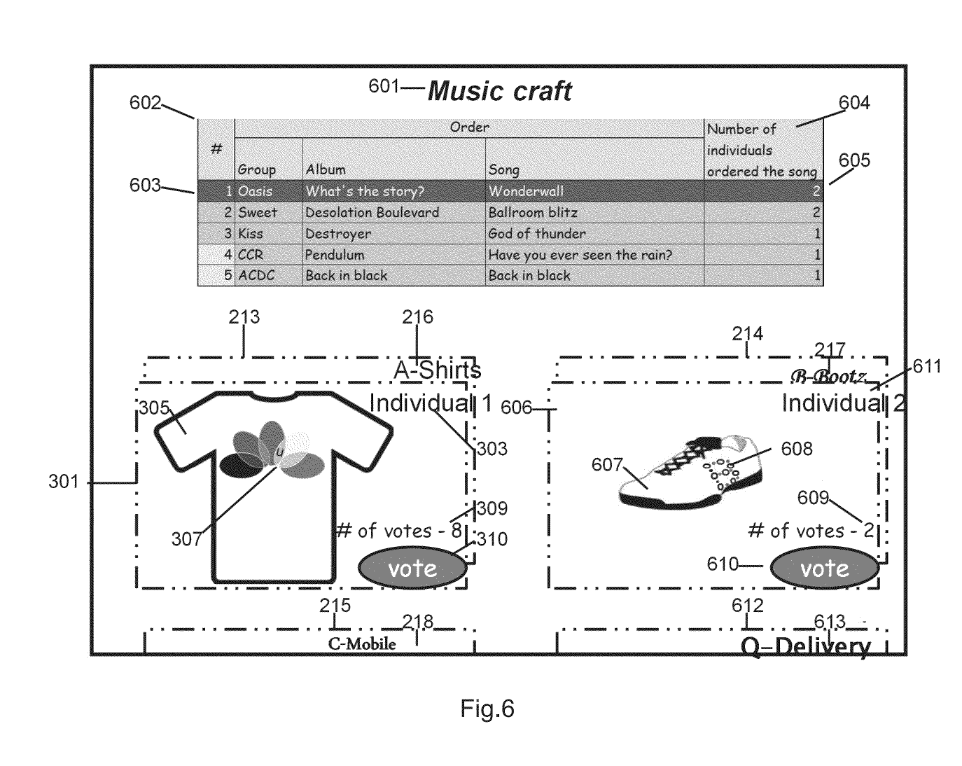

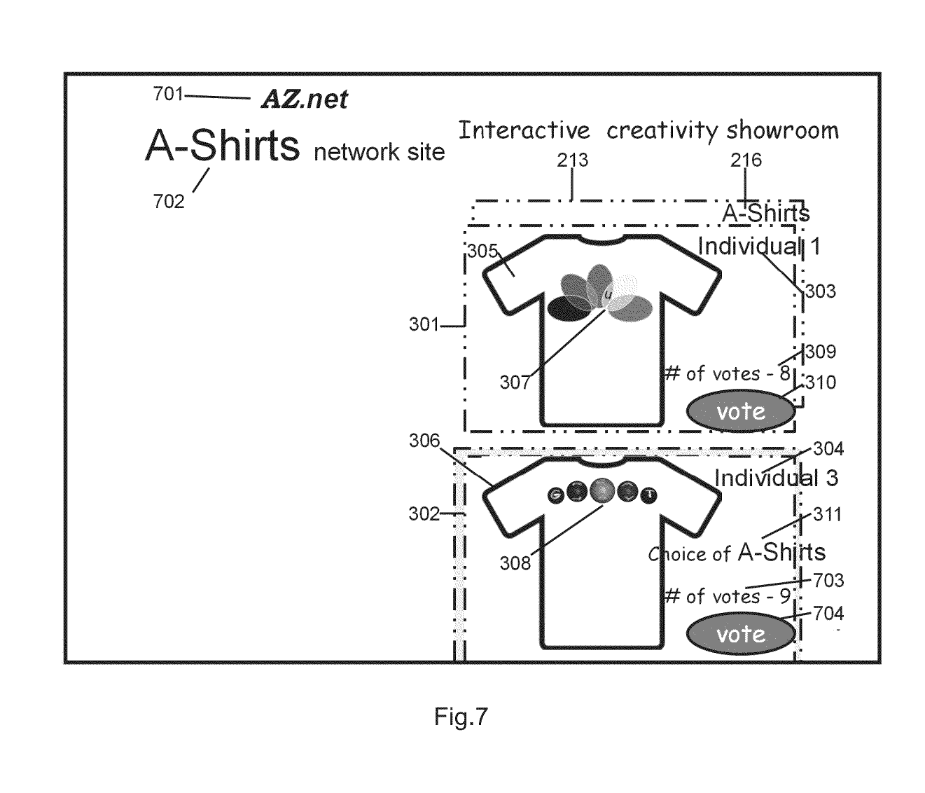

Sequence of order for displaying list items in the described embodiment is based on relative sequence of making such entries both by companies and by individuals unless user of the system makes some adjustments by filtering or sorting the information. Although, the sequence can be dependent on some different list (FIG. 6 and FIG. 7). For instance, this could be list in which individuals' items are ranged according to the algorithm of different system not described within these materials. FIG. 6, for instance, shows some Internet based music service 601 with playlist 602 driven by individual orders. Column 604 in the given example displays number of Individuals ordered particular song. When number one (603) of the list 602 is played, it causes creativity offers 301, 606 and others of such individuals and correlated orders 213, 214, 215, 612 and others been displayed as well. Companies' names 216, 217, 218, 613 are displayed within such orders. So, in such embodiment, offer item with corresponding request item will be displayed per sequence of that master list every time corresponding individual name or an item associated with such name will appear on such master list. Such additional exposure of creativity work via different system would reinforce the aforementioned benefits both counterparties would gain. It's assumed that there might be more than one system master list that employs correlated list items as a “slave” list. By other words, multiple systems may play/display correlated list items whether simultaneously or successively. Moreover, the combined correlational list can be used whether in whole or by its parts by “static” database network systems as well. For instance, some web site containing information about a user or a group of users may use entries of such user/users to the correlational list and/or correlated items of such list. An example of such application of the combined correlational list is depicted on the FIG. 7. Some company 702 (216) having its' web page associated with Internet based social network 701, can use combined correlational list with items 301, 302 that correlate with this company's order 213. Obviously, there may be more than one order by this company as well as there may be more than one company or subsidiary involved in the list creation. This way such system that doesn't employ dynamic presentation of its database to the public as a prime functionality, still would be able to incorporate dynamic fractions of the correlational list wherever correspondence between two system databases would be found.

This kind of the web site can also contain a list of Individuals (friends, for instance). Then, the correlational list would look similar to the one shown on the FIG. 6. In this case as well in application described on the FIG. 7, the master list may use as criteria, not only internal lists, sequences, etc., but also chronological sequence of the interactive request-offer creativity system entries.

Also, there is an option for some embodiments to filter entries to the system before adding them to the combined correlational list. Besides, there can be a mode or setting of the system that will make an entry invisible for the most or all of the system users. For instance, an individual's entry can be fully seen by a company that has placed an order which is correlated with the individual's entry, but such item can be partially or fully blanked for everyone else. Besides, there might be conditions set force that would cause altering visibility mode

It's assumed that format of correlational list entries can be different than such described by the embodiment herein. It can be text, drawing, picture, photography, video, audio, etc. It may be used for the commercial purposes as in the embodiment above or may have no direct commercial intention, like be of an educational, humanitarian, scientific or artistic nature. Also, it's assumed that this invention covers embodiments that involve only one type of entries, for instance they could be offers. Besides, groups of entries can be based on general topics or categories. It's also assumed that there may be more than two types of entities that participate in the list composition. Besides, any of the entity types may submit more than one entry in any of the correlated items group. For example, there can be an embodiment like the one described above, in which there are two or more orders within one group of correlated items. Different kind of rights and obligations can be assigned to each of the entity types participating in the system. So, such possibilities and limitations can differ for different embodiments.

What is claimed is:

1. A method of a combined correlational list composition comprising the steps of:
connecting into a first database on a website;
creating at least one item;
adding at least one item to the first database;
creating at least one correlated item;
adding at least one correlated item to a second database of correlated items;
filtering input items using selection criteria;
processing input items;
grouping individual items with correlated items and converting them into combined correlational list of items by using the computer algorithm;
displaying continued combined correlational list based on at least one master list;
adding a voting point to at least one correlated item;
selecting at least one correlated item;
optionally removing at least one item from the combined correlational list of items; and
optionally deleting at least one item from the database.

2. The method according to claim 1, wherein the master list is based on a sequence of a first item entry relative to a second item entry, and a sequence of an entry of a first item correlated with the first item relative to an entry of a second item correlated with the first item.

3. The method according to claim 1, wherein the master list is based on a sequence of a client's item within different list of items.

4. The method according to claim 1, wherein the creation of a correlated item is performed using provided template.

5. The method according to claim 1, wherein at least one correlated item is created using at least one different correlated item which is displayed within the combined correlational list.

6. The method according to claim 1, wherein while displaying combined correlational list at least one correlated item is at least partially hidden from at least a part of the system users and conditions under which this information becomes visible are set force by the system's rules.

7. An Interactive request-offer creativity system comprising:
at least one requesting items database,
at least one offering items database, which the requesting items database contains at least one request item, wherein the offering items database contains at least one offering item, the requesting and the offering items correlate one with each other, and
at least one computer program containing an algorithm for request and offer items creation,
collaboration on an item creation by providing a device for employing at least one existing entry for new item creation, combined correlational list creation, continuously displaying the combined correlational list according to at least one master list, adding voting points and selecting at least one combined correlational list item.
